(19) United States
(12) Patent Application Publication
(10) Pub. No.: US 2026/0073418 A1
(43) Pub. Date: Mar. 12, 2026

(54) NATURAL LANGUAGE MODEL BASED REAL ESTATE TREND PREDICTIONS

(71) Applicant: CoreLogic Solutions, LLC, Irvine, CA (US)

(72) Inventors: Matthew Delventhal, Temecula, CA (US); Kien Trong Trinh, San Diego, CA (US); Uyen Hoang, San Diego, CA (US); Bin He, Philadelphia, PA (US); David Stiff, Cambridge, MA (US)

(21) Appl. No.: 19/325,290

(22) Filed: Sep. 10, 2025

Related U.S. Application Data
(60) Provisional application No. 63/693,610, filed on Sep. 11, 2024.
(60) Provisional application No. 63/837,017, filed on Jul. 1, 2025.

(51) Int. Cl. G06Q 30/0201; G06F 40/20

(52) U.S. Cl. CPC G06Q 30/0206; G06F 40/20

(57) ABSTRACT

Systems and methods for providing real estate trends and other insights based on a natural language process of text data, including various news sources, to a specified market (e.g., national, local). In some embodiments, the real estate prediction system performs semantic-based analysis to determine a sentiment associated with a source. For example, the real estate prediction system can access an embedding system to generate embeddings for words and phrases contained within a source. These embeddings can be input to an LLM for determination of a general sentiment of the source, or used directly in an LLM. The real estate prediction system perform additional semantic analysis, such as word counting, to classify and organize the content of sources. Based on the generated sentiments, the real estate prediction system can generate predictions, estimations, and other insights relating to the sources.

### CROSS-REFERENCE TO RELATED APPLICATIONS

The present application claims priority to U.S. Provisional Patent No. 63/837,017, filed on Jul. 1, 2025, entitled “NATURAL LANGUAGE MODEL BASED REAL ESTATE TREND PREDICTIONS,” and U.S. Provisional Patent No. 63/693,610, filed on Sep. 11, 2024, entitled “NATURAL LANGUAGE MODEL BASED REAL ESTATE TREND PREDICTIONS,” which are hereby incorporated by reference in their entirety.

### BACKGROUND

The real estate market may be different in different geographic regions. For example, property valuations and price trends may vary in different geographic regions based on a variety of factors. Such factors can include the prevalence of hazards, the presence of quality jobs, the quality of schools, and/or the like.

### SUMMARY

In some aspects, the techniques described herein relate to a system, comprising: a computer-readable storage medium storing program instructions; and one or more processors, wherein the program instructions, when executed by the one or more processors, cause the one or more processors to: access a source; determine, based on the source, a plurality of word counts, wherein each word count comprises an occurrence frequency of a word and a word sentiment associated with the word; determine, based on the source, a plurality of word embeddings within an embedding space, wherein locations of the plurality of word embeddings within the embedding space indicate a similarity between each word of the source; input the plurality of word embeddings and the plurality of word counts into a natural language processing model, the natural language processing model to output a source sentiment associated with the source; determine a confidence score associated with the source sentiment, wherein the confidence score indicates a correlation between the source sentiment and the source; and determine a trend prediction based on the source sentiment.

In some aspects, the techniques described herein relate to a system, wherein the source includes at least one of an article, a newspaper article, a blog article, an online publication, a print publication, a magazine, an editorial, a review, a brochure, an opinion, a press release, a post, a photo, a video, an audio file, a diagram, a column, or a feature.

In some aspects, the techniques described herein relate to a system, wherein the trend prediction is one of a predicted property cost estimate, rental estimate, mortgage rate, inventory, demand, or a statistic.

In some aspects, the techniques described herein relate to a system, wherein the program instructions, when executed, further cause the one or more processors to: determine, using a forecasting engine a baseline property value for a property, wherein the property; receive a request for a property value estimation for the property; access the baseline property value, weekly property data, and the source sentiment; determine the property value estimation, wherein determination of the property value estimation comprises: input, into the forecasting engine, the baseline property value, the weekly property data and the source sentiment; and adjust the baseline property value based on the weekly property data and the source sentiment to determine the property value estimation; and display the property value estimation.

In some aspects, the techniques described herein relate to a system, wherein the program instructions further cause the system to store the property value estimation in a results cache.

In some aspects, the techniques described herein relate to a system, wherein the program instructions, when executed, further cause the one or more processors to generate, by the forecasting engine, an interpolation of the property value estimation using cubic spline interpolation.

In some aspects, the techniques described herein relate to a system, wherein the program instructions, when executed, further cause the one or more processors to: generate a sentiment score plot based on the source sentiment; and display the sentiment score plot and the trend prediction on a graphical user interface.

In some aspects, the techniques described herein relate to a method, comprising: accessing a source; determining, based on the source, a plurality of word counts, wherein each word count comprises an occurrence frequency of a word and a word sentiment associated with the word; determining, based on the source, a plurality of word embeddings within an embedding space, wherein locations of the plurality of word embeddings within the embedding space indicate a similarity between each word of the source; inputting the plurality of word embeddings and the plurality of word counts into a natural language processing model, the natural language processing model to output a source sentiment associated with the source; determining a confidence score associated with the source sentiment, wherein the confidence score indicates a correlation between the source sentiment and the source; and determining a trend prediction based on the source sentiment.

In some aspects, the techniques described herein relate to a method, wherein the source includes at least one of an article, a newspaper article, a blog article, an online publication, a print publication, a magazine, an editorial, a review, a brochure, an opinion, a press release, a post, a photo, a video, an audio file, a diagram, a column, or a feature.

In some aspects, the techniques described herein relate to a system, wherein the trend prediction is one of a predicted property cost estimate, rental estimate, mortgage rate, inventory, demand, or a statistic.

In some aspects, the techniques described herein relate to a method, further comprising: determining, using a forecasting engine a baseline property value for a property, wherein the property; receiving a request for a property value estimation for the property; accessing the baseline property value, weekly property data, and the source sentiment; determining the property value estimation, wherein determination of the property value estimation comprises: inputting, into a forecasting engine, the baseline property value, the weekly property data and the source sentiment; and adjusting the baseline property value based on the weekly property data and the source sentiment to determine the property value estimation; and displaying the property value estimation.

In some aspects, the techniques described herein relate to a method, further comprising storing the property value estimation in a results cache.

In some aspects, the techniques described herein relate to a method, further comprising generating, by the forecasting engine, an interpolation of the property value estimation using cubic spline interpolation.

In some aspects, the techniques described herein relate to a method, further comprising: generating a sentiment score plot based on the source sentiment; and displaying the sentiment score plot and the trend prediction on a graphical user interface.

In some aspects, the techniques described herein relate to a non-transitory computer-readable medium storing specific computer-executable instructions that, when executed by a processor of a computing device, cause the computing device to: access a source; determine, based on the source, a plurality of word counts, wherein each word count comprises an occurrence frequency of a word and a word sentiment associated with the word; determine, based on the source, a plurality of word embeddings within an embedding space, wherein locations of the plurality of word embeddings within the embedding space indicate a similarity between each word of the source; input the plurality of word embeddings and the plurality of word counts into a natural language processing model, the natural language processing model to output a source sentiment associated with the source; determine a confidence score associated with the source sentiment, wherein the confidence score indicates a correlation between the source sentiment and the source; and determine a trend prediction based on the source sentiment.

In some aspects, the techniques described herein relate to a non-transitory computer-readable medium, wherein the source includes at least one of an article, a newspaper article, a blog article, an online publication, a print publication, a magazine, an editorial, a review, a brochure, an opinion, a press release, a post, a photo, a video, an audio file, a diagram, a column, or a feature.

In some aspects, the techniques described herein relate to a non-transitory computer-readable medium, wherein the trend prediction is one of a predicted property cost estimate, rental estimate, mortgage rate, inventory, demand, or a statistic.

In some aspects, the techniques described herein relate to a non-transitory computer-readable medium, wherein the computer-executable instructions, when executed, further cause the computing device to: determine, using a forecasting engine a baseline property value for a property, wherein the property; receive a request for a property value estimation for the property; access the baseline property value, weekly property data, and the source sentiment; determine the property value estimation, wherein determination of the property value estimation comprises: input, into a forecasting engine, the baseline property value, the weekly property data and the source sentiment; and adjust the baseline property value based on the weekly property data and the source sentiment to determine the property value estimation; and display the property value estimation.

In some aspects, the techniques described herein relate to a non-transitory computer-readable medium, wherein the computer-executable instructions, when executed, further cause the computing device to store the property value estimation in a results cache.

In some aspects, the techniques described herein relate to a non-transitory computer-readable medium, wherein the computer-executable instructions, when executed, further cause the computing device to generate, by the forecasting engine, an interpolation of the property value estimation using cubic spline interpolation.

### BRIEF DESCRIPTION OF THE DRAWINGS

Various features will now be described with reference to the following drawings. Throughout the drawings, reference numbers can be re-used to indicate correspondence between referenced elements. The drawings are provided to illustrate examples described herein and are not intended to limit the scope of the disclosure.

FIG. 1 is a schematic block diagram of an example network environment in which a real estate prediction system may operate, according to various aspects of the present disclosure.

FIG. 2 is an example data flow process in which the real estate prediction system may operate to predict real estate trends based on sentiment analysis of sources, according to various aspects of the present disclosure.

FIG. 3 is a block diagram illustrating components of an example computing system that can be used to implement the various systems and methods described herein.

FIG. 4 is an example data flow process in which a forecasting engine may operate to provide on-demand property value forecasting utilizing property data and generated sentiment data, according to various aspects of the present disclosure.

FIG. 5A depicts an example sentiment score distribution determined by the sentiment system of the real estate prediction system, according to aspects of the present disclosure.

FIGS. 5B and 5C depict example score plots determined by the sentiment system of the real estate prediction system, according to aspects of the present disclosure.

FIG. 6 is an example routine for predicting real estate trends based on sentiment analysis of sources, according to various aspects of the present disclosure.

### DETAILED DESCRIPTION

Generally described, aspects of the present disclosure relate to efficient mechanisms for predicting real estate trends based on natural language processing of text-based sources (e.g., newspapers, articles, television broadcasts) and sentiment analysis.

As described herein, sources may contain a wealth of information relating to the property or real estate markets. For example, news articles may indicate local real estate booms in a particular location, a “sub-prime disaster” indicative of an ongoing mortgage crisis, or recent increases in average sale prices for flipped homes, etc. Key phrases, “buzz” words, or other jargon may be repeated throughout sources depending on the reported event. These natural language indicators and other colloquial phrases may indicate a general mood or sentiment expressed in the source. In some examples, sentiments expressed in sources can further indicate upcoming trends in the market, such as by demonstrating how potential buyers or sellers will or should act in the near future.

Current techniques for trend prediction based on news sources is limited. Although general machine learning models and other large language models (LLM) techniques may have been applied to predict real estate trends, such real estate trends are typically generated at a national level, as opposed to local markets. In addition, the amount of news content pushed through various sources occurs at a high frequency. Because markets in various geographical locations may be vastly different, LLM-based sentiment on a national level may overlook smaller niche markets and produce inaccurate results. Real estate market trends can change abruptly in a matter of days, and current techniques for predictions may not be equipped to handle large amounts of source content.

As will be appreciated by one of skill in the art in light of the present disclosure, the embodiments disclosed herein improve the ability of computing systems, such as the real estate prediction system, to provide real estate trends and other insights based on a sentiment analysis of various news sources, to a specified market (e.g., national, local (e.g., neighborhood, zip code, city, county, state, etc.). In some embodiments, the real estate prediction system performs semantic-based analysis to determine a sentiment associated with a source. For example, the real estate prediction system can access an embedding system to generate embeddings for words and phrases contained within a source. These embeddings can be input to an LLM or other language model for determination of a general sentiment of the source. In another example, the real estate prediction system performs additional semantic analysis, such as word counting, to classify and organize the content of sources. The word counting may, in some examples, be used to compute a sentiment score. This information can also be input to the LLM for sentiment analysis. Based on the generated sentiments and/or embeddings, the real estate prediction system can generate predictions, estimations, and other insights relating to the sources. This may allow for up-to-date trend predictions in relevant real estate markets based on an inferred mood or sentiment of sources. Sentiment scores may also allow for forecasters or other processes to form subjective opinions of various situations in the real estate market.

In addition to generating sentiment scores and other sentiment-related insights, systems described herein relate to generation of property value forecasts or estimations based on property data and sentiment analysis. Specifically, the real estate prediction system may include a forecasting engine configured to provide on-demand property value forecasting utilizing property data and generated sentiment data. To make informed decisions, individuals often need access to the most current or up-to-date information relating to relevant property values. However, systems that attempt to implement daily processing of property value estimations may incur extensive computing resource usage (e.g., extensive processor utilization, memory usage, network bandwidth usage, cloud computing resource usage, etc.). This may be due to the large amounts of property data that need to be processed by models in order to generate predictions. When performed daily or at other automated intervals, computing resource usage may be compounded. Described herein is a system to provide on-demand property value forecasts. Upon the receipt of a trigger event, such as an on-demand request, the real estate prediction system may provide, via a forecasting engine, predicted property values based on property data (refreshed weekly) and sentiment analysis. Because the forecasting engine may provide property value estimates upon a requested demand, computing resource usage may be reduced.

In addition to reducing the amount of computing resource usage, the on-demand forecasting system may reduce computing time delays or latency. For example, the on-demand structure of the system optimizes the processing of data by preprocessing certain information (e.g., baseline information). Because certain information has been preprocessed, the amount of data to process may be reduced. As such, upon a trigger event, the system may provide a property value estimate without a noticeable delay, such as a delay noticeable to a user (e.g., 30 ms or shorter, where providing a property value estimate without noticeable delay may include generating and presenting a property value estimate to a user in a user interface (e.g., a graphical user interface) within a time it takes to load a web page or other content page or other user interface in response to the user taking an action that results in the trigger event).

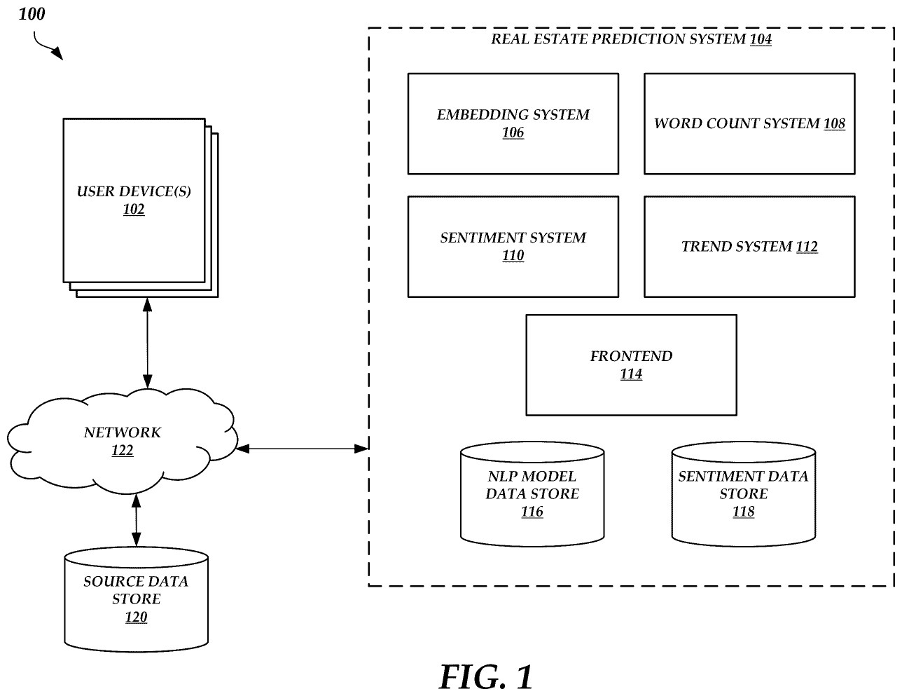

FIG. 1 is a schematic block diagram of an example network environment 100 in which a real estate prediction system 104 may operate. The real estate prediction system 104 may be configured to provide real estate trends and other insights based on a sentiment analysis of various news sources.

As shown in FIG. 1, the network environment 100 includes user device(s) 102 (hereinafter referred to as “user device 102” for ease of reference), real estate prediction system 104, source data store 120, and network 122. Real estate prediction system 104 includes embedding system 106, word count system 108, sentiment system 110, trend system 112, frontend 114, natural language processing (NLP) model data store 116, and sentiment data store 118. The components of the real estate prediction system 104 may be communicatively coupled via network 122. In addition, network 122 may connect the user device 102 to the real estate prediction system 104 and various components of the real estate prediction system 104. The network environment 100 and components of network environment 100 can include various hardware components and software components and can provide functionality as described further herein. In addition, components of network environment 100 and the real estate prediction system 104 can include more or less components than shown in FIG. 1.

In various aspects, communication among the various components of the example network environment 100 and the real estate prediction system 104 may be accomplished via any suitable device, systems, methods, and/or the like. For example, the real estate prediction system 104 may communicate with the user device 102 and any datastores, such as the source data store 120, via any combination of the network 122 or any other wired or wireless communication networks, methods (e.g., Bluetooth, WiFi, infrared, cellular, and/or the like). As further described below, the network 122 may comprise, for example, one or more internal or external networks, the Internet, and/or the like.

Network 122 of the network environment 100 can include any appropriate network, including wired network, wireless network, or combination thereof. For example, network 122 may be a personal area network, local area network, wide area network, cable network, satellite network, cellular network, or any other such network or combination thereof. As a further example, the network 122 may be a publicly accessible network of linked networks, possibly operated by various distinct parties, such as the Internet. Protocols and components for communicating via the Internet or any other types of communication networks are known to those skilled in the art of computer communications and thus, need not be described in more detail herein. In various embodiments, the network 122 may be a private or semi-private network, such as a corporate or university intranet. The network 122 may include one or more wireless networks, such as a Global System for Mobile Communications (GSM) network, a Code Division Multiple Access (CDMA) network, a Long-Term Evolution (LTE) network, C-band, mmWave, sub-6 GHZ, or any other type of wireless network. The network 122 can use protocols and components for communicating via the Internet or any of the other aforementioned types of networks. For example, the protocols used by the network 122 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art of computer communications and thus, need not be described in more detail herein.

In various implementations, the network 122 can represent a network that may be local to a particular organization, e.g., a private or semi-private network, such as a corporate or university intranet. In some implementations, devices may communicate via the network 122 without traversing an external network, such as the Internet. In some implementations, devices connected via the network 122 may be walled off from accessing the Internet. As an example, the network 122 may not be connected to the Internet. Accordingly, e.g., the user device 102 may communicate with the real estate prediction system 104 directly (via wired or wireless communications) or via the network 122, without using the Internet. Thus, even if the network 122 or the Internet is down, the real estate prediction system 104 may continue to communicate and function via direct communications (and/or via the network 122).

User device 102 may be used to access various components of the network environment 100 and the real estate prediction system 104 over the network 122. User device 102 illustratively correspond to any computing device that provides a means for a user or admin to interact with components of the real estate prediction system 104. For example, a user, with user device 102, may access the real estate prediction system 104 via the frontend 114 to request or view a generated prediction (e.g., trend graph) relating to a certain geographical location. In some examples, the frontend 114 may be implemented on user device 102. Of course, other activities may also be performed by a user with a user device 102. User device 102 may include user interfaces or dashboards that connect a user with a machine, system, or device. In various implementations, user device 102 include computer devices with a display and a mechanism for user input (e.g., mouse, keyboard, voice recognition, touch screen, and/or the like). In various implementations, the user device 102 include desktops, tablets, e-readers, servers, wearable device, laptops, smartphones, computers, gaming consoles, and the like. In some implementations, user device 102 can access a cloud provider network via the network 122 to view or manage their data and computing resources, as well as to use websites and/or applications hosted by the cloud provider network. Elements of the cloud provider network may also act as clients to other elements of that network. Thus, user device 102 can generally refer to any device accessing a network-accessible service as a client of that service.

Source data store 120 may be configured to store any source of data or information relating to real estate markets. Sources may contain information relating to the property or real estate markets. Sources stored in the source data store 120 can include any article, publication, magazine, editorial, review, brochure, opinion, press release, post, photo, diagram, column, feature, etc. For example, a daily news article published in a newspaper may include updates to the recent plunge in average flipping prices in X geographical location, or a recent trend surge in rent prices during the summer. Sources in the source data store 120 may also include other visual-based content, such as television news, clips, social media posts, forum posts, videos, sound bites, streams, blogs, and other content.

In some embodiments, sources may be directed to certain geographical areas or locations. For example, an article stored in the source data store 120 may contain reports of the rising rent costs over the past month for properties in New York City. Some sources may provide national coverage, such as reports directed to the overall housing market across the country.

In some embodiments, the real estate prediction system 104 may access a portion of a source, such as a snippet or section of the source for purposes of predicting trends. A source may be chunked or parsed into various portions by the real estate prediction system 104.

Real estate prediction system 104 may be configured to provide real estate trends and other insights based on a sentiment analysis of various sources, such as sources accessed from the source data store 120. In some embodiments, the real estate prediction system 104 accesses sources from the source data store 120 on a daily, monthly, bi-monthly basis (or any other time interval) to generate predictions for various real estate markets. The real estate prediction system 104 may generate current predictions as well as future predictions for various real estate markets (e.g., local, national) and other insights relating to property information (e.g., average prices, predicted sales points, etc.). By analyzing the content of news sources, the real estate prediction system 104 may determine a sentiment(s) relating to the source and generate predictions based on the determined sentiment(s).

Real estate prediction system 104 may have access to various databases, models, and other applications that allow the real estate prediction system 104 to provide trends and insights. As shown in FIG. 1, the real estate prediction system 104 includes various systems, such as the embedding system 106, the word count system 108, the sentiment system 110, the trend system 112, and the frontend 114. In addition, the real estate prediction system 104 has access to various databases, such as the NLP data store 116, and the sentiment data store 118. Real estate prediction system 104 may have access to additional components not shown in FIG. 1, or may contain less components than as shown. Although each component of the real estate prediction system 104 will be discussed with respect to specific processes to be executed by said component, it is understood that the real estate prediction system 104 may delegate any task to any of the components for execution.

Embedding system 106 may be configured to generate embeddings relating to the content of sources. Embedding system 106 may classify the sources by generating embeddings relating to the text of the source. As noted herein, a source, such as an article, may contain various words or phrases indicative of a sentiment or mood. The embedding system 106 may quantify the source by generating embeddings relating to the various words or phrases contained with the source. To generate an embedding, the embedding system 106 may parse the source and associate various words with a location in an embedding space, that may be represented by a vector. An embedding space as used herein may refer to an n-dimensional space that contains item vectors in such a way that similar items are located relatively close to each other, while dissimilar items are located relatively far apart. For example, the embedding system 106 may generate an embedding relating to the word “crash” (e.g., market crash, stock crash, etc.) and also generate an embedding relating to the word “slump” and “slowdown” (e.g., market slump, market slowdown, etc.). Because these words are generally similar and indicate the same type of event occurrence, the embedding system 106 may place these words relatively close to one another in the embedding space. Embeddings generated by embedding system 106 may be used by the real estate prediction system 104 in generating predictions and trends.

Word count system 108 may be configured to classify and quantify the words contained within a source. As noted herein, a source, such as an article, may contain various repeated words or phrases indicative of a sentiment or mood. The frequency of a certain word or phrase may indicate an overall mood expressed in the source. In addition, the comparison between “negative” vs. “positive” words may also contribute towards the overall sentiment. To classify the words of a source, the word count system 108 may, for a particular source, determine the number of times a particular word is used. For example, the word count system 108 may parse an article and determine the following word counts: increase (3 times), up (44 times), rise (7 times), skyrocket (1). In this example, the word count system 108 may also determine that the article contains the following word counts: decrease (4 times), down (34 times), fall (2 times), plummet (4 times). The word count system 108 may access any model, algorithm, or process to determine the word count of a source, or multiple sources. In addition to determining the word counts, the word count system 108 may determine that the first list contains words that are generally positive, whereas the second list contains words that are generally negative. The word count system 108 may label or associate additional information with the counted words. In some examples, the words counted by the word count system 108 may be input into an LLM for further processing and determination of a general sentiment.

Sentiment system 110 may be configured to determine a sentiment (or sentiments) associated with a source. A sentiment as utilized herein may refer to an attitude, opinion, mood, feeling, etc. that is expressed within a source. In some embodiments, the sentiment may relate to an author's mood towards a current event relating to the real estate market (e.g., apprehension at an ongoing downturn in the market). In some examples, the sentiment may be qualitative, such as an indication of whether the mood of the source is very positive, positive, neutral, negative, very negative, angry, confused, frustrated, hopeful, happy, sad, etc. Sentiments may also include a percentage, number, rating, etc. which may indicate a mood of the source. To generate a sentiment relating to source, the sentiment system 110 may access or receive embeddings generated by the embedding system 106. The sentiment system 110 may access a model, such as an LLM or NLP model stored in the NLP data store 116 to input embeddings for determination of a sentiment. In some embodiments, the sentiment system 110 determines a sentiment or multiple sentiments or associated with a particular source. In some embodiments, the sentiment system 110 determines a sentiment or multiple sentiments or an average sentiment associated with a particular topic or event (e.g., property prices, housing market forecasts, impending economic downturns or inflations).

In some examples, the sentiment system 110 may determine a sentiment score (or a confidence score) associated with the determined sentiment. The sentiment score can be indicative of a confidence at which the determined sentiment is associated with the event or source. In some examples, the sentiment score is a number between 0 and 1 for a “positive” sentiment, 1 indicating maximum confidence in the sentiment, and 0 indicating a minimum confidence in the sentiment. In some examples, the sentiment score can also be between −1 and 0 for a “negative” sentiment, −1 indicating a maximum confidence, and a 0 indicating a minimum confidence. Other configurations and metrics may be used to describe the confidence of a determined sentiment.

In some embodiments, the sentiment system 110 (or other component of the real estate prediction system 104) determines a sentiment (and a sentiment score) of a source based on non-textual content, such as audio and/or video content. To determine a sentiment, the sentiment system 110 may analyze the tone, inflection, connotation, pitch, intonation, length, etc. of spoken conversation within the source. For example, the sentiment system 110 can access an article or video news segment in which news anchors are speaking and providing updates to the housing market. The sentiment analysis system 110 may, by the NLPs or other machine learning models, analyze the voice of the news anchors and determine a sentiment associated with the source, a sentiment of a particular speaker within the source, a sentiment of a group of speakers within the source, and the like. Similar to above, the sentiment system 110 can determine a sentiment score or sentiment scores associated with the determined sentiment(s) of a video news broadcast or other audio or video-based source.

NLP data store 116 may be configured to store models, algorithms, or other processes to be accessed by the real estate prediction system 104. Models stored in the NLP data store 116 may include any engine, service, application, program, process, etc. configured to determine or identify a sentiment associated with a source or content within a source (e.g., a current event). In some embodiments, the models stored in the NLP model data store 116 may include artificial intelligence (AI) models such as machine learning (ML) models, deep learning (DL) models, large language models (LLMs), and the like. LLMs can include a natural language processing (NLP) model configured to generate a sentiment based on the input embeddings. In some embodiments, the sentiment system 110 may access a single LLM stored in the NLP data store 116 to generate a sentiment(s), or may access a stack (or multiple) LLMs.

Sentiment data store 118 may be configured to store sentiments determined by the sentiment system 110. In some embodiments, sentiments and the related sentiment score are both stored in the sentiment data store 118. In some embodiments, the sentiments relating to a particular article, or topic, or snippet, etc. may be updated periodically. In some embodiments, the information stored in the sentiment data store 118 may be updated periodically (e.g., daily, monthly, b-monthly, quarterly, yearly) upon the generation of new sentiments relating to new sources.

Trend system 112 can be configured to generate predicted trends, predictions, estimates, and other insights based on the determined sentiments stored in the sentiment data store 118. Predictions or trends can include any information relating to the sentiments based on the sources of the source data store 120, such as predicted property cost estimates, rental estimates, mortgage rates, inventory, demand, and other statistics. Trends, predictions, insights, and other information determined by the trend system 112 may be stored in additional data stores.

In some embodiments, the trend system 112 determines an average sentiment on a periodic basis, such as a monthly basis. For example, the sentiment system 110 may determine the general sentiment of an article (or article snippet) as being generally negative or positive. The trend system 112 may obtain a monthly or other periodic (e.g., daily, weekly, bi-weekly, etc.) sentiment measure by taking an average of the sentiments from various articles. The average can be based on a calculation of the number of positive texts (embeddings) minus the number of negative texts (embeddings) divided by the number of texts (embeddings). This calculation can be updated periodically, such as on a daily, weekly, bi-weekly, monthly, etc. basis. In some embodiments, the trend system 112 may generate a graph to show the trend in sentiment over time. In some embodiments, the trend system 112 generates a report, graph, pictogram, or other mode of display.

To facilitate interaction between the real estate prediction system 104 and a user of the user device 102 via the network 122, the real estate prediction system 104 includes the frontend 114. Frontend 114 may include any presentation layer (e.g., experience layer, user interface, etc.) such as a user-facing interface or platform through which a user of the user device 102 may access and interact with the real estate prediction system 104. Predictions, trends, and other reports generated by the real estate prediction system 104 may be presented in the frontend 114 via an interface.

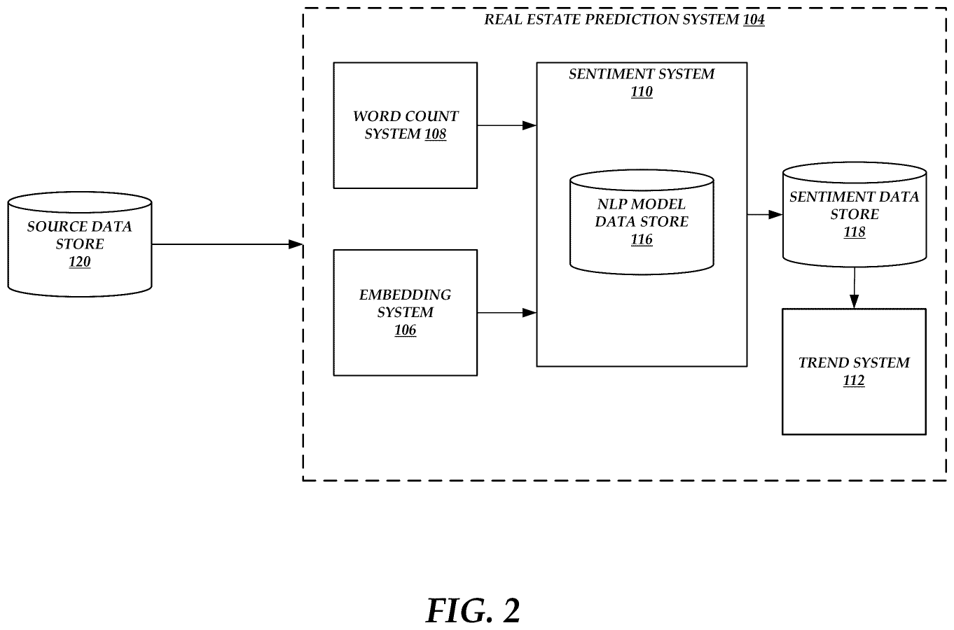

FIG. 2 is an example data flow process in which the real estate prediction system 104 may operate to predict real estate trends based on sentiment analysis of sources, according to various aspects of the present disclosure.

As shown in FIG. 2, the real estate prediction system 104 may access information stored in the source data store 120. Sources stored in the source data store 120 can include any article (e.g., from a newspaper, blog, online publication, etc.), publication, magazine, editorial, review, brochure, opinion, press release, post, photo, video, audio, diagram, column, feature, etc. For example, a transcription of a television news report may be stored as a text file in the source data store 120. In another example, posts from a local agent's social media account may also be stored in the source data store 120.

To generate real estate trends based on sources, such as news sources, social media sources, and/or the like, the real estate prediction system 104 may execute various processes according to different pathways. For example, the real estate prediction system 104 may access various components to parse the source as a first step in predicting a sentiment. Depending on the type of source and/or the context in which a trend prediction is generated (e.g., local vs. national), the real estate prediction system 104 may decide to access one component over the other. In some embodiments, the real estate prediction system 104 may access both the word count system 108 and the embedding system 106 in determining predictions or trends. In this case, both the real estate prediction system 104 and the embedding system 106 may access the same source(s).

In some embodiments, the real estate prediction system 104 accesses the word count system 108 to calculate a sentiment score. As described herein, the word count system 108 may be configured to classify and quantify the words contained within a source. For example, the word count for each word can include an occurrence frequency, or a number of times that the word is included within the source. The word counts may indicate a general sentiment or mood associated with a source. For example, a plurality of positive words (e.g., up, increase, affordable, rising, etc.) may be counted and associated with a positive sentiment. In addition, negative words, or phrases (e.g., bust, downturn, downgrade, decline, etc.) may be counted and associated with a negative sentiment. Other moods, sentiments, labels, etc. may be utilized by the word count system 108.

In some embodiments, the real estate prediction system 104 accesses the embedding system 106 to generate embeddings relating to words or phrase within sources. To generate an embedding, the embedding system 106 may parse the source and associate various words with a location in an embedding space, that may be represented by a vector. The embedding space may contain item vectors (e.g., words or phrases) in such a way that similar items are located relatively close to each other, while dissimilar items are located relatively far apart. Embeddings may contain information indicative of the originating source, distances between other embeddings, and other semantic or non-semantic information.

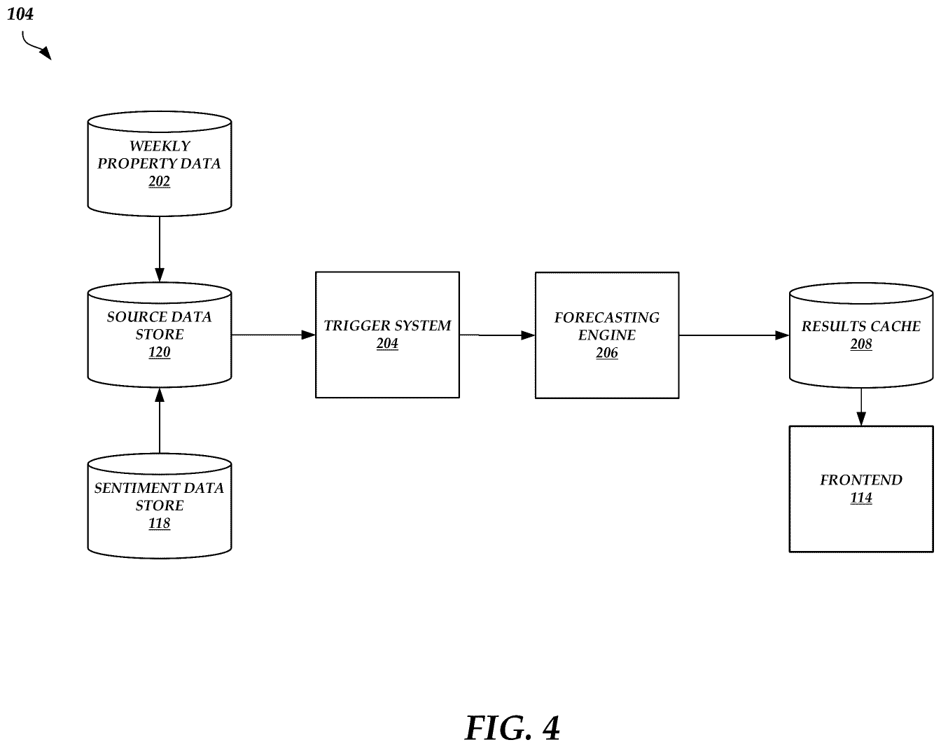

After parsing the source, the real estate prediction system 104 may access a LLM (or multiple LLMs), a small language model, or other technique for determination of a sentiment. As shown in FIG. 4, the sentiment system 110 may access both the word count system 108 and the embedding system 106 in determining a sentiment. As noted herein, a sentiment as utilized herein may refer to an attitude, opinion, mood, feeling, etc. that is expressed within a source. In some embodiments, the sentiment may relate to an author's mood towards a current event relating to the real estate market (e.g., apprehension at an ongoing downturn in the market). In some examples, the sentiment may be qualitative, such as an indication of whether the mood of the source is very positive, positive, neutral, negative, very negative, angry, confused, frustrated, hopeful, happy, sad, etc. Sentiments may also include a percentage, number, rating, etc. which may indicate a mood of the source. To generate a sentiment relating to source, the sentiment system 110 may access or receive embeddings generated by the embedding system 106 and/or words counted (and/or labeled) by the word count system 108. The sentiment system 110 may access a model, such as an LLM or NLP model stored in the NLP data store 116 to input embeddings or counted words for determination of a sentiment. In some embodiments, the sentiment system 110 determines a sentiment or multiple sentiments or associated with a particular source. In some embodiments, the sentiment system 110 determines a sentiment or multiple sentiments or an average sentiment associated with a particular topic or event (e.g., property prices, housing market forecasts, impending economic downturns or inflations, etc.). For example, in the case when the sentiment system 110 inputs embeddings of an article with negative words, the output of the LLM may be a negative, bleak, or worrisome sentiment.

In some examples, the sentiment system 110 may determine a sentiment score (or a confidence score) associated with the determined sentiment. The sentiment score can be indicative of a confidence at which the determined sentiment is associated with the event or source. In some examples, the sentiment score is a number between 0 and 1 for a “positive” sentiment, 1 indicating maximum confidence in the sentiment, and 0 indicating a minimum confidence in the sentiment. In some examples, the sentiment score can also be between −1 and 0 for a “negative” sentiment, −1 indicating a maximum confidence, and a 0 indicating a minimum confidence. Other configurations and metrics may be used to describe the confidence of a determined sentiment.

In some embodiments, the sentiment system 110 may determine a sentiment or plurality of sentiment associated with multiple sources. In some embodiments, the sentiment system 110 may determine an average sentiment associated with a plurality of sources. The average may be a weighted average, in some cases.

Upon determination of a sentiment or plurality of sentiments, the sentiment data store 118 may store sentiments determined by the sentiment system 110. In some embodiments, sentiments and the related sentiment score are both stored in the sentiment data store 118. In some embodiments, the sentiments relating to a particular article, or topic, or snippet, etc. may be updated periodically. In some embodiments, the information stored in the sentiment data store 118 may be updated periodically (e.g., daily, monthly, b-monthly, quarterly, yearly) upon the generation of new sentiments relating to new sources.

Trend system 112 may access the sentiment data store 118 to determine a predicted trend, estimate, or other insight based on the sources. Predictions or trends can include any information relating to the sentiments based on the sources of the source data store 120, such as predicted property cost estimates, rental estimates, mortgage rates, inventory, demand, and other statistics. Trends, predictions, insights, and other information determined by the trend system 112 may be stored in additional data stores.

In some embodiments, the trend system 112 determines an average sentiment on a periodic basis, such as a daily, weekly, bi-weekly, monthly, etc. basis. For example, the sentiment system 110 may determine the general sentiment of an article (or article snippet) as being generally negative or positive. The trend system 112 may obtain a periodic sentiment measure by taking an average of the sentiments from various articles. The average can be based on a calculation of the number of positive texts (embeddings) minus the number of negative texts (embeddings) divided by the number of texts (embeddings). This calculation can be updated periodically, such as on a daily, weekly, bi-weekly, monthly, etc. basis. In some embodiments, the trend system 112 may generate a graph to show the trend in sentiment over time. In some embodiments, the trend system 112 generates a report, graph, pictogram, or other mode of display to illustrate the generated prediction. For example, based on multiple news articles relating to the recent surges in rent prices in X location, the trend system 112 may predict that the rent prices will continue to rise in the near future, and may output this prediction in a timeline/graph.

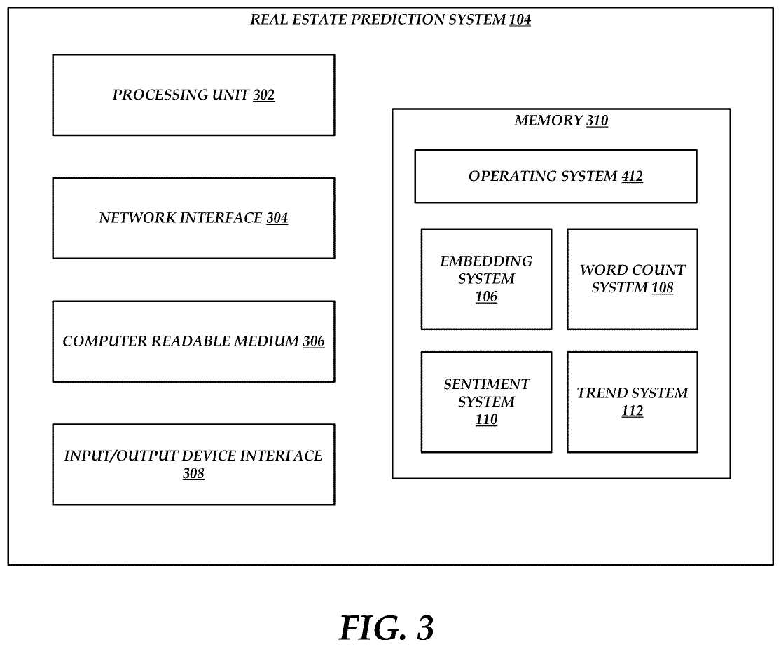

FIG. 3 is a block diagram illustrating components of an example computing system that can be used to implement the various systems and methods described herein.

The general architecture of the system depicted in FIG. 3 includes an arrangement of computer hardware and software that may be used to implement aspects of the present disclosure. The hardware may be implemented on physical electronic devices, as discussed in greater detail below. The system may include many more (or fewer) elements than those shown in FIG. 3. It is not necessary, however, that all of these generally conventional elements be shown in order to provide an enabling disclosure. Additionally, the general architecture illustrated in FIG. 3 may be used to implement one or more of the other components illustrated in the figures. As illustrated, the system includes a processing unit 302, a network interface 304, a computer-readable medium drive 306, and an input/output device interface 308, and memory 310, all of which may communicate with one another by way of a communication bus.

The network interface 304 may provide connectivity to one or more networks or computing systems. The processing unit 302 may thus receive information and instructions from other computing systems or services via the network. The processing unit 402 may also communicate to and from memory 310 and further provide output information for an optional display (not shown) via the input/output device interface 308. The input/output device interface 308 may also accept input from an optional input device (not shown).

The memory 310 may contain computer program instructions (grouped as units in some embodiments) that the processing unit 302 executes in order to implement one or more aspects of the present disclosure, along with data used to facilitate or support such execution. While shown in FIG. 3 as a single set of memory 310, memory 310 may in practice be divided into tiers, such as primary memory and secondary memory, which tiers may include (but are not limited to) random access memory (RAM), 3D XPOINT memory, flash memory, magnetic storage, and the like. For example, primary memory may be assumed for the purposes of description to represent a main working memory of the system, with a higher speed but lower total capacity than a secondary memory, tertiary memory, etc.

The memory 310 may store an operating system 312 that provides computer program instructions for use by the processing unit 302 in the general administration and operation of the real estate prediction system 104. The memory 310 may further include computer program instructions and other information for implementing aspects of the present disclosure. For example, in one embodiment, the memory 310 includes the embedding system embedding system 106, the word count system 108, the sentiment system 110, the trend system 112, and frontend 114 (not shown). Each of these components may represent code executable to perform the processes described herein.

The system of FIG. 3 is one illustrative configuration of such a device, of which others are possible. For example, while shown as a single device, a system may in some embodiments be implemented as a logical device hosted by multiple physical host devices. In other embodiments, the system may be implemented as one or more virtual devices executing on a physical computing device. While described in FIG. 3 as a real estate prediction system 104 similar components may be utilized in some embodiments to implement other devices shown herein.

FIG. 4 is an example data flow process in which a forecasting engine 206 may operate to provide on-demand property value forecasting utilizing property data and generated sentiment data, according to various aspects of the present disclosure. To provide the most accurate and up-to-date property value predictions, property values may need to be refreshed daily. However, daily processing of property value forecasts can incur significant computing resource usage. This may occur due to the massive amounts of property data accessed by models for predicting property values on a daily basis. This can result in extensive processor utilization, memory usage, network bandwidth usage, cloud computing resource usage, and the like. As such, the system described herein relates to an on-demand architecture for predicting property values. In some embodiments, the real estate prediction system 104 leverages periodic (e.g., hourly, daily, weekly, bi-weekly, monthly, etc.) baseline data and real estate market sentiment analysis to provide daily property value estimates.

In some embodiments, the real estate prediction system 104 accesses weekly property data 202. Weekly property data 202 may comprise any information relating to properties, such as real property values. Weekly property data 202 can also include information affecting the value of real properties, such as economic variables, unemployment rates, macroeconomic data, mortgage rates, treasury rates, interest rates, supply and demand, economy health, or any other market events. Weekly property data 202 may be accessed or retrieved by the real estate prediction system 104 on a periodic basis (e.g., weekly). In some embodiments, retrieval of weekly property data 202 may be scheduled to occur at the same day and time. It is noted that the term “weekly property data 202” is not meant to be limiting and can include any period or interim, such as hourly, daily, weekly, bi-weekly, monthly, bi-monthly, quarterly, etc. It is noted that if the period of the property data is daily, the real estate prediction system 104 may still achieve the technical benefits described herein due to the preprocessing and other processes as described.

In some embodiments, the weekly property data 202 is stored at a persistent storage location, such as the source data store 120 or other data storage location (e.g., cloud-based). Weekly property data 202 may be stored at any low-cost or easily accessible location that is retrievable by the real estate prediction system 104. Weekly property data 202 may be stored at any storage location that allows quick access or retrieval by the real estate prediction system 104 or any component of the real estate prediction system 104. Persistent storage locations can include any storage that provides fast retrieval times, such as solid state drives (SSDs), non-volatile memory storage, hybrid drives, cloud storage, etc.

In addition to accessing the weekly property data 202, the real estate prediction system 104 may access information from the sentiment data store 118. As described herein, the sentiment data store 118 may be configured to store sentiments determined by the sentiment system 110. In some embodiments, sentiments and the related sentiment score are both stored in the sentiment data store 118. In some embodiments, the sentiments relating to a particular article, or topic, or snippet, etc. may be updated periodically. In some embodiments, the information stored in the sentiment data store 118 may be updated periodically (e.g., daily, monthly, b-monthly, quarterly, yearly) upon the generation of new sentiments relating to new sources. In some embodiments, the sentiment data store 118 stores information relating to cached daily updates. This can include sentiments relating to news articles or other sources that are refreshed on a daily basis. As will be described below, the real estate prediction system 104 may utilize both weekly property data 202 and sentiment information from the sentiment data store 118 to provide on-demand property value forecasts.

Weekly property data 202 and sentiment analysis data may be used to train the models of the forecasting engine 206. For example, the forecasting engine 206 may access these data sets in order to adjust the weights of each tier (e.g., state, county, property). This allows the forecasting engine 206 to accurately predict property values at each tier according to updated weekly property data 202 and sentiment analysis. In some embodiments, the weekly property data 202 may be used to tune the models of the forecasting engine 206 to reflect the most updated values. Weekly property data 202 may be input into the models to output property values. The generated property values may then be compared against ground truth property values and the difference may be used to adjust and fine tune the models.

Trigger system 204 may be configured to receive requests for on-demand property value forecasts. In some embodiments, trigger system 204 may be implemented as an API or other user-facing interface in which a user may request property value estimations. The real estate prediction system 104 may process the property data (e.g., weekly property data 202, source data store 120, sentiment information) upon input to the trigger system 204.

Upon receiving a request for an on-demand property value forecast to the trigger system 204, the forecasting engine 206 may process the property data (e.g., weekly property data 202) and sentiment information according to the processes described above. In some embodiments, the forecasting engine 206 includes a model, such as a machine learning (ML) model to generate predicted property values.

In some embodiments, the forecasting engine 206 estimates property values using a tiered architecture or framework. In some embodiments, the forecasting engine 206 may preprocess certain information prior to the receipt of a trigger event. The forecasting engine 206 may preprocess certain information that will be used to generate a predicted property value (e.g., baseline data). Baseline data can include any information that is considered to be the “starting point” or initial property value that the forecasting engine 206 may adjust based on additional processing (e.g., additional tiers). For example, the forecasting engine 206 may calculate a baseline statewide property value prior to a trigger event. This property value may be the starting point for further processing by the forecasting engine 206 upon a trigger event (e.g., request for an estimate). In some embodiments, the forecasting engine 206 preprocesses property data at the state level to generate the baseline statewide property value. The baseline statewide property value may be calculated prior to receipt of an on-demand request. In some cases, the baseline statewide property value is calculated based on state-based information, such as state tax rates, characteristics (e.g., geographical location, population, terrain), popularity, sentiment, etc. For example, the baseline statewide property value for the state of California may be based on the California property tax rates, characteristics such as being a coastal state or being known as a popular place to live, population, and the like. The baseline statewide property value may represent an average property value for all properties in the state based on the state-based information.

To generate a prediction, the forecasting engine 206 may adjust the preprocessed baseline statewide property value according to the tiered framework. Using the preprocessed baseline statewide property value, the forecasting engine 206 may then adjust the baseline statewide property value on additional tiers upon the receipt of the on-demand request, such as the county tier and property tier. At the county tier, the forecasting engine 206 may adjust the baseline statewide property value according to county-level factors, such as average property values within the county and other county-based characteristics. Similar to this county tier analysis, the forecasting engine 206 may then adjust the estimated property value based on property-specific factors. This can include any property characteristics or features that affect the value of the property.

In addition to implementing a tiered framework in adjusting the estimated property value, the forecasting engine 206 may include additional layers or features. For example, the forecasting engine 206 may include a temporal interpolation base layer. This layer may be configured to make interpolations between weekly data points (from the weekly property data 202). Because the weekly property data 202 is refreshed weekly (rather than daily), the temporal interpolation base layer may utilize cubic spline interpolation between the weekly data points. In addition, cyclical factors or day-of-week modeling may be used for adjustments of the estimated property values. The forecasting engine 206 may also include a sentiment adjustment layer in which the sentiment analysis may be integrated. This layer may model market volatility and other sentiment impact adjustments based on the sentiment analysis processes described above. In addition, the forecasting engine 206 can include a caching and retrieval layer. This layer may adjust property value estimations using time-decay confidence metrics. This may allow the forecasting engine 206 to better approximate the property values according to decay modeling.

Upon generation of estimated property values by the forecasting engine 206, the real estate prediction system 104 may store the estimated property values in a results cache 208. The results cache 208 may organize and store estimated values relating to specific properties for quick access. This may allow for quick retrieval of property value estimates that have been recently generated by the forecasting engine 206. For example, if a first user requests an on-demand estimate for a specific property, the forecasting engine 206 may generate and store the estimate in the results cache 208. A second request for an estimate relating to the same property may be retrieved from the results cache 208, rather than being re-generated by the forecasting engine 206. This may reduce processing costs as results may be retrieved from the results cache 208 rather than re-running the forecasting engine 206. However, when updated weekly property data 202 is accessed and upon an on-demand request, the forecasting engine 206 may generate an updated estimated property value to replace the existing information in the results cache 208.

Estimated property values may be presented to a user via the frontend 114. Frontend 114 may be implemented as an API or other user-facing interface for the user to request on-demand property value estimation and view the results of the estimation analysis. As described herein, the frontend 114 may be any interface configured to display results of the forecasting engine 206 and/or real estate prediction system 104 to a user, via the user device 102.

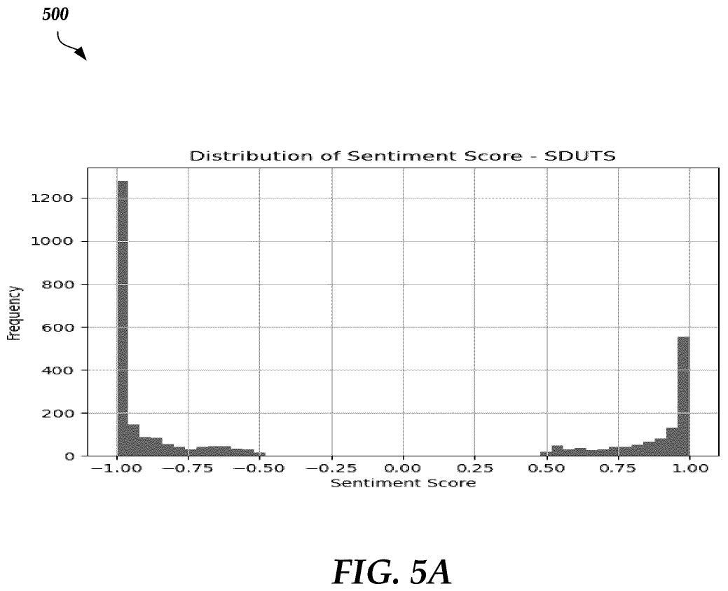

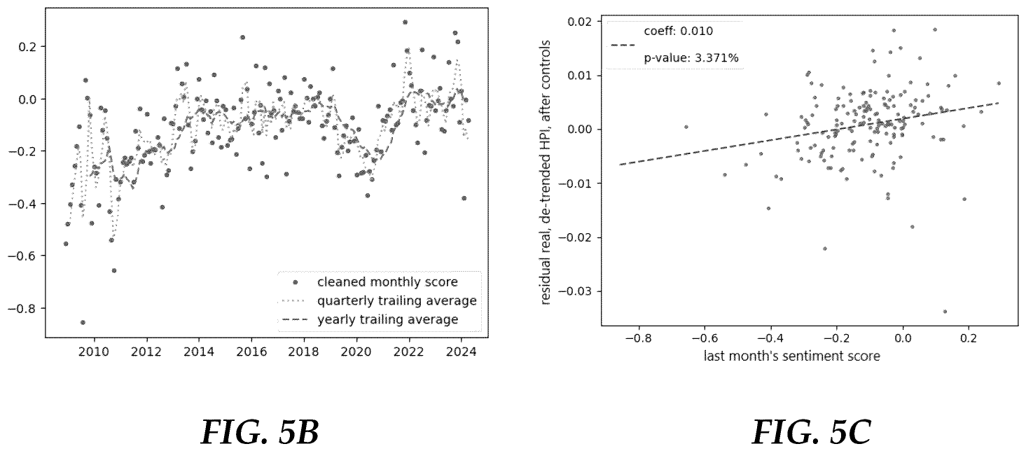

FIG. 5A depicts an example sentiment score distribution 500 determined by the sentiment system 110 of the real estate prediction system 104, according to aspects of the present disclosure. In some embodiments, sentiment score distribution 500 represents sentiment scores from multiple sources. Average sentiment scores and the frequency of occurrence (such as over multiple sources) may be included.

FIGS. 5B and 5C depict example score plots determined by the sentiment system 110 of the real estate prediction system 104. Score plots can include average sentiment scores. For example, the average sentiment scores over a month may be shown. In addition, plot lines, such as the quarterly trailing average and the yearly trailing average may be shown on the score plot 510. Trend lines and other information may be included in the score plot 510.

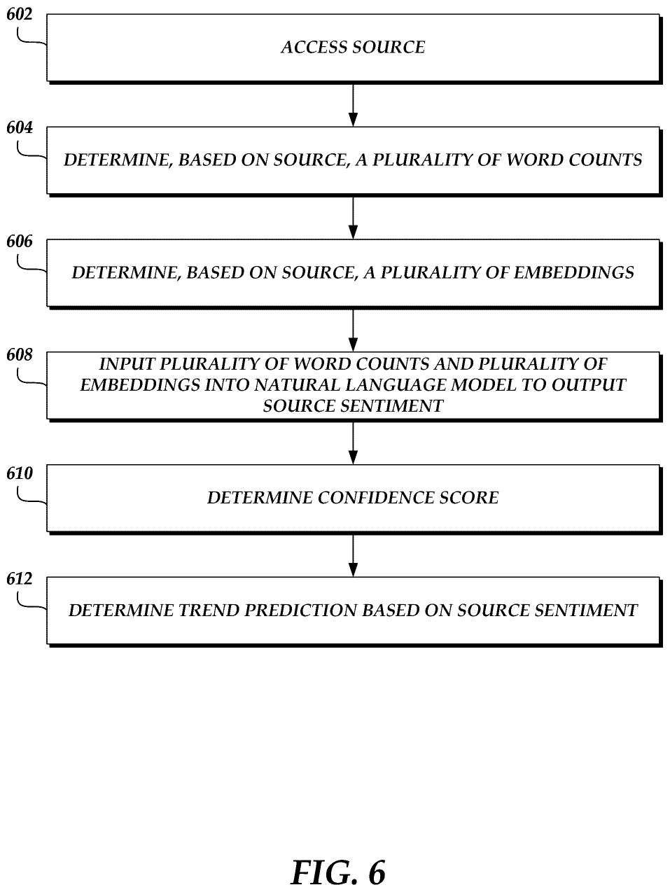

FIG. 6 is an example routine for predicting real estate trends based on sentiment analysis of sources. The routine 600 may be executed by the real estate prediction system 104. Specifically, the routine 600 may be executed by a processor, such as processing unit 302, shown in FIG. 3.

At block 602, the real estate prediction system 104 accesses a source (or multiple sources). Sources stored in the source data store 120 can include any article (e.g., from a newspaper, blog, online publication, etc.), print publication, magazine, editorial, review, brochure, opinion, press release, post, photo, video, audio, diagram, column, feature, etc.

At block 604, the word count system 108 determines, based on the source, a plurality of word counts. In some embodiments, the word count system 108 may be configured to classify and quantify the words contained within the source. For example, the word count for each word can include an occurrence frequency, or a number of times that the word is included within the source. The word counts may indicate a general sentiment or mood associated with a source. In addition, negative words, or phrases (e.g., bust, downturn, downgrade, decline, etc.) may be counted and associated with a negative sentiment. Other moods, sentiments, labels, etc. may be utilized by the word count system 108.

At block 606, the embedding system 106 determines, based on the source, a plurality of embeddings. To generate an embedding, the embedding system 106 may parse the source and associate various words with a location in an embedding space, which may be represented by a vector. The embedding space may contain item vectors (e.g., words or phrases) in such a way that similar items are located relatively close to each other, while dissimilar items are located relatively far apart. Embeddings may contain information indicative of the originating source, distances between other embeddings, and other semantic or non-semantic information.

At block 608, the sentiment system 110 inputs the plurality of word counts and the plurality of embeddings into a natural language model to output a source sentiment. In some embodiments, the source sentiment is associated with the source. In some embodiments, the natural language model includes an LLM (or multiple LLMs), a small language model, or other technique for determination of a sentiment. In some embodiments, the sentiment system 110 may access both the word count system 108 and the embedding system 106 in determining a sentiment. As noted herein, a sentiment as utilized herein may refer to an attitude, opinion, mood, feeling, etc. that is expressed within a source. In some embodiments, the sentiment may relate to an author's mood towards a current event relating to the real estate market. In some examples, the sentiment may be qualitative, such as an indication of whether the mood of the source is very positive, positive, neutral, negative, very negative, angry, confused, frustrated, hopeful, happy, sad, etc. Sentiments may also include a percentage, number, rating, etc. which may indicate a mood of the source. To generate a sentiment relating to source, the sentiment system 110 may access or receive embeddings generated by the embedding system 106 and/or words counted (and/or labeled) by the word count system 108. The sentiment system 110 may access a model, such as an LLM or NLP model stored in the NLP data store 116 to input embeddings or counted words for determination of a sentiment. In some embodiments, the sentiment system 110 determines a sentiment or multiple sentiments or associated with a particular source. In some embodiments, the sentiment system 110 determines a sentiment or multiple sentiments or an average sentiment associated with a particular topic or event (e.g., property prices, housing market forecasts, impending economic downturns or inflations, etc.). For example, in the case when the sentiment system 110 inputs embeddings of an article with negative words, the output of the LLM may be a negative, bleak, or worrisome sentiment.

In some embodiments, the sentiment system 110 may determine a sentiment or plurality of sentiment associated with multiple sources. In some embodiments, the sentiment system 110 may determine an average sentiment associated with a plurality of sources. The average may be a weighted average, in some cases.

Upon determination of a sentiment or plurality of sentiments at block 508, the sentiment data store 118 may store sentiments determined by the sentiment system 110. In some embodiments, sentiments and the related sentiment score are both stored in the sentiment data store 118. In some embodiments, the sentiments relating to a particular article, or topic, or snippet, etc. may be updated periodically. In some embodiments, the information stored in the sentiment data store 118 may be updated periodically (e.g., daily, monthly, b-monthly, quarterly, yearly) upon the generation of new sentiments relating to new sources.

At block 610, the sentiment system 110 determines a confidence score associated with the source sentiment. The sentiment score or confidence score can be indicative of a confidence at which the determined sentiment is associated with the event or source (e.g., a confidence score indicates a correlation between the source sentiment and the source). In some examples, the sentiment score is a number between 0 and 1 for a “positive” sentiment, 1 indicating maximum confidence in the sentiment, and 0 indicating a minimum confidence in the sentiment. In some examples, the sentiment score can also be between −1 and 0 for a “negative” sentiment, −1 indicating a maximum confidence, and a 0 indicating a minimum confidence. Other configurations and metrics may be used to describe the confidence of a determined sentiment.

At block 612, the trend system 112 determines a trend prediction based on the source sentiment. Trend system 112 may access the sentiment data store 118 to determine a predicted trend, estimate, or other insight based on the sources. Predictions or trends can include any information relating to the sentiments based on the sources of the source data store 120, such as predicted property cost estimates, rental estimates, mortgage rates, inventory, demand, and other statistics. Trends, predictions, insights, and other information determined by the trend system 112 may be stored in additional data stores.

Some or all of the statistical analysis methods described herein may be performed and fully automated by a computer system. The computer system may, in some cases, include multiple distinct computers or computing devices (e.g., physical servers, workstations, storage arrays, network service computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a network service computing system whose processing resources are shared by multiple distinct business entities or other users.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware-based computer processor of the computing device. In some embodiments, such processes or portions thereof may be implemented on multiple computing devices and/or multiple processors, serially or in parallel.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm elements described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A system, comprising:
a computer-readable storage medium storing program instructions; and
one or more processors, wherein the program instructions, when executed by the one or more processors, cause the one or more processors to:
access a source;
determine, based on the source, a plurality of word counts, wherein each word count comprises an occurrence frequency of a word and a word sentiment associated with the word;
determine, based on the source, a plurality of word embeddings within an embedding space, wherein locations of the plurality of word embeddings within the embedding space indicate a similarity between each word of the source;
input the plurality of word embeddings and the plurality of word counts into a natural language processing model, the natural language processing model to output a source sentiment associated with the source;
determine a confidence score associated with the source sentiment, wherein the confidence score indicates a correlation between the source sentiment and the source; and
determine a trend prediction based on the source sentiment.

2. The system of claim 1, wherein the source includes at least one of an article, a newspaper article, a blog article, an online publication, a print publication, a magazine, an editorial, a review, a brochure, an opinion, a press release, a post, a photo, a video, an audio file, a diagram, a column, or a feature.

3. The system of claim 1, wherein the trend prediction is one of a predicted property cost estimate, rental estimate, mortgage rate, inventory, demand, or a statistic.

4. The system of claim 1, wherein the program instructions, when executed, further cause the one or more processors to:
determine, using a forecasting engine a baseline property value for a property, wherein the property;
receive a request for a property value estimation for the property;
access the baseline property value, weekly property data, and the source sentiment;
determine the property value estimation, wherein determination of the property value estimation comprises:
input, into a forecasting engine, the baseline property value, the weekly property data and the source sentiment; and
adjust the baseline property value based on the weekly property data and the source sentiment to determine the property value estimation; and
display the property value estimation.

5. The system of claim 4, wherein the program instructions further cause the system to store the property value estimation in a results cache.

6. The system of claim 4, wherein the program instructions, when executed, further cause the one or more processors to generate, by the forecasting engine, an interpolation of the property value estimation using cubic spline interpolation.

7. The system of claim 1, wherein the program instructions, when executed, further cause the one or more processors to:
generate a sentiment score plot based on the source sentiment; and
display the sentiment score plot and the trend prediction on a graphical user interface.

8. A method, comprising:
accessing a source;
determining, based on the source, a plurality of word counts, wherein each word count comprises an occurrence frequency of a word and a word sentiment associated with the word;
determining, based on the source, a plurality of word embeddings within an embedding space, wherein locations of the plurality of word embeddings within the embedding space indicate a similarity between each word of the source;
inputting the plurality of word embeddings and the plurality of word counts into a natural language processing model, the natural language processing model to output a source sentiment associated with the source;
determining a confidence score associated with the source sentiment, wherein the confidence score indicates a correlation between the source sentiment and the source; and
determining a trend prediction based on the source sentiment.

9. The method of claim 8, wherein the source includes at least one of an article, a newspaper article, a blog article, an online publication, a print publication, a magazine, an editorial, a review, a brochure, an opinion, a press release, a post, a photo, a video, an audio file, a diagram, a column, or a feature.

10. The method of claim 8, wherein the trend prediction is one of a predicted property cost estimate, rental estimate, mortgage rate, inventory, demand, or a statistic.

11. The method of claim 8, further comprising:
determining, using a forecasting engine a baseline property value for a property, wherein the property;
receiving a request for a property value estimation for the property;
accessing the baseline property value, weekly property data, and the source sentiment;
determining the property value estimation, wherein determination of the property value estimation comprises:
inputting, into the forecasting engine, the baseline property value, the weekly property data and the source sentiment; and
adjusting the baseline property value based on the weekly property data and the source sentiment to determine the property value estimation; and
displaying the property value estimation.

12. The method of claim 11, further comprising storing the property value estimation in a results cache.

13. The method of claim 11, further comprising generating, by the forecasting engine, an interpolation of the property value estimation using cubic spline interpolation.

14. The method of claim 8, further comprising:
generating a sentiment score plot based on the source sentiment; and
displaying the sentiment score plot and the trend prediction on a graphical user interface.

15. A non-transitory computer-readable medium storing specific computer-executable instructions that, when executed by a processor of a computing device, cause the computing device to:
access a source;
determine, based on the source, a plurality of word counts, wherein each word count comprises an occurrence frequency of a word and a word sentiment associated with the word;
determine, based on the source, a plurality of word embeddings within an embedding space, wherein locations of the plurality of word embeddings within the embedding space indicate a similarity between each word of the source;
input the plurality of word embeddings and the plurality of word counts into a natural language processing model, the natural language processing model to output a source sentiment associated with the source;
determine a confidence score associated with the source sentiment, wherein the confidence score indicates a correlation between the source sentiment and the source; and
determine a trend prediction based on the source sentiment.

16. The non-transitory computer-readable medium of claim 15, wherein the source includes at least one of an article, a newspaper article, a blog article, an online publication, a print publication, a magazine, an editorial, a review, a brochure, an opinion, a press release, a post, a photo, a video, an audio file, a diagram, a column, or a feature.

17. The non-transitory computer-readable medium of claim 15, wherein the trend prediction is one of a predicted property cost estimate, rental estimate, mortgage rate, inventory, demand, or a statistic.

18. The non-transitory computer-readable medium of claim 15, wherein the computer-executable instructions, when executed, further cause the computing device to:
determine, using a forecasting engine a baseline property value for a property, wherein the property;
receive a request for a property value estimation for the property;
access the baseline property value, weekly property data, and the source sentiment;
determine the property value estimation, wherein determination of the property value estimation comprises:
input, into a forecasting engine, the baseline property value, the weekly property data and the source sentiment; and
adjust the baseline property value based on the weekly property data and the source sentiment to determine the property value estimation; and
display the property value estimation.

19. The non-transitory computer-readable medium of claim 18, wherein the computer-executable instructions, when executed, further cause the computing device to store the property value estimation in a results cache.

20. The non-transitory computer-readable medium of claim 18, wherein the computer-executable instructions, when executed, further cause the computing device to generate, by the forecasting engine, an interpolation of the property value estimation using cubic spline interpolation.
